(19) United States
(12) Patent Application Publication
(10) Pub. No.: US 2005/0042055 A1
(43) Pub. Date: Feb. 24, 2005

(54) Deck safety slip pin system

(76) Inventor: Dale R. Weir, Ashtabula, OH (US)

Correspondence Address: RANKIN, HILL, PORTER & CLARK LLP, 4080 ERIE STREET, WILLOUGHBY, OH, 44094-7836, US

(21) Appl. No.: 10/896,478

(22) Filed: Jul. 21, 2004

Related U.S. Application Data
(60) Provisional application No. 60/495,962, filed on Aug. 19, 2003.

(51) Int. Cl. B60P 3/08

(52) U.S. Cl. 410/26; 70/181

(57) ABSTRACT

A deck safety slip pin system is provided for car carrier and trailers. The slip pin system comprises a locking device. The locking device includes a pawl that is pivotally affixable to a member on the car carrier or trailer. The pawl is biased against a deck support post. As the deck is hydraulically raised, teeth upon the pawl ratchet over receptacles in the support post. If the hydraulic system fails, the deck is stopped from moving downwards by the teeth in the pawl of the locking device. The locking device further includes a release mechanism to disengage or move the pawl away from the support post.

### PRIORITY CLAIM

This application claims priority to currently pending U.S. Provisional Application Ser. No. 60/495,962 filed on Aug. 19, 2003, the entire disclosure of which is incorporated by reference herein.

### BACKGROUND OF THE INVENTION

Car carriers (single vehicle) and/or car carrying trailers have been used for years as transportation devices for moving automobiles on the road from factories to dealers and between other locations. A typical trailer may be loaded with up to 12-18 automobiles depending upon trailer and automobile size. A significant advantage to transport trailers is the ability to secure a second row of automobiles above a first row of automobiles. Automobiles within upper rows are supported by decks that are raised and lowered hydraulically during loading and unloading operations. Decks are in turn supported by support posts, and are raised by a hydraulic lifting system of pumps, cylinders, etc.

In existing practice two types of deck raising systems are used. In a first system, posts that support the deck are static. Multiple post sliders are fixed to the deck and slide over the static support posts. The deck and post sliders are affixed to a hydraulic lifting system that can raise and lower the deck as required. In an alternate system the deck and post sliders are affixed to the support posts. The posts are not static, but move, typically in a telescoping manner, to raise the deck. The movable support posts are affixed to a hydraulic lifting system that can raise and lower the posts and deck as required.

In both types of deck raising systems hydraulic fluid is forced into the hydraulic lifting system to move a deck upwards. Once the deck is raised to a desired position the moving parts of the deck raising system are locked in relation to the static parts for safety reasons. This prevents undesired movement of the deck in case of failure within the hydraulic system. Locking is currently performed using receptacles within the support posts and locking pins (Miller pins) placed therein. In a system where the support post is static, a pin is placed through a receptacle in a position below the deck and post slider to prevent the deck and post slider from moving downwards. In a system where the support post is movable, a pin is placed through a receptacle in the movable support post just above a static sleeve located below the support post to prevent the support post from moving downwards.

The transport trailer operator is expected to fit the locking pins through the receptacles to provide the mechanical safety lock of the deck in its raised position. Because the receptacles may be located in an elevated position, application of the pin is not always an easy task. Periodically, the transport trailer operator neglects to apply the locking pin or does so incorrectly. In these instances support of the upper decks depends solely on the hydraulic lifting system. During occasions of hydraulic system failure, upper support decks may drop causing damage to vehicles in lower rows and potentially injuring the transport trailer operator. Additionally, during a hydraulic system failure the weight of the unsupported deck forces a great deal of hydraulic fluid out of the system creating a spill incident. Accordingly there exists a need in the art for an automatic mechanical locking device that does not rely on operator actuation. There further exists a need in the art for such a locking device that will minimize hydraulic fluid loss in instances of failure in the hydraulic system. Still further there exists a need for a locking device that will lock a deck in a partially raised position if hydraulic system failure occurs during the raising process.

### SUMMARY OF THE INVENTION

The present invention overcomes these and other disadvantages in the prior art. The deck safety slip pin system of the present invention provides a mechanical locking device that is actuated automatically and is operable as the deck is raised. Direct operator intervention is only required to unlock the device prior to lowering the deck and to reset the device prior to its subsequent use. Upon failure of the hydraulic lifting system, the locking device prevents the support deck from falling, thus, avoiding situations of damage or injury. Additionally excess pressure is not created in the hydraulic lifting system during failure of the system so large amounts of hydraulic fluid are not lost.

In accordance with the present invention the locking device includes a pawl pivotally affixable to a car carrier or trailer. The pawl includes at least one tooth for selective engagement with a receptacle upon the support post of the car carrier and a biasing device that engages the pawl and biases the pawl against the support post. Additionally, the locking device includes an actuatable release mechanism for disengaging the pawl tooth from the receptacle upon the support post.

In an alternate embodiment of the invention, the deck safety slip pin system also includes a post slider that may be attached to a car carrier or trailer in place of or in addition to post sliders that already are in place on the car carrier.

These and other aspects of the invention are herein described in particularized detail with reference to the accompanying figures.

### BRIEF DESCRIPTION OF THE FIGURES

FIG. 1 is a side elevational view of a car carrying trailer affixed to a tractor;

FIG. 2 is a perspective view of a section of the trailer including the slip pin system of the present invention;

FIG. 3 is a side elevational view of the slip pin system with a locking device in a locked position;

FIG. 4 is a side elevational view of the slip pin system with the locking device in an unlocked position;

FIG. 5 is perspective view of the locking device;

FIG. 6 is an inverted perspective view of the locking device of FIG. 5; and

FIG. 7 is a perspective view of a second embodiment of the slip pin system.

### DETAILED DESCRIPTION OF PREFERRED AND ALTERNATE EMBODIMENTS

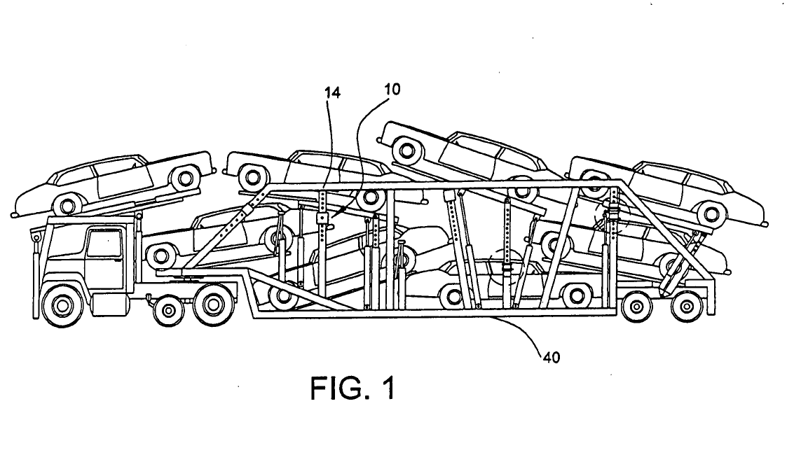

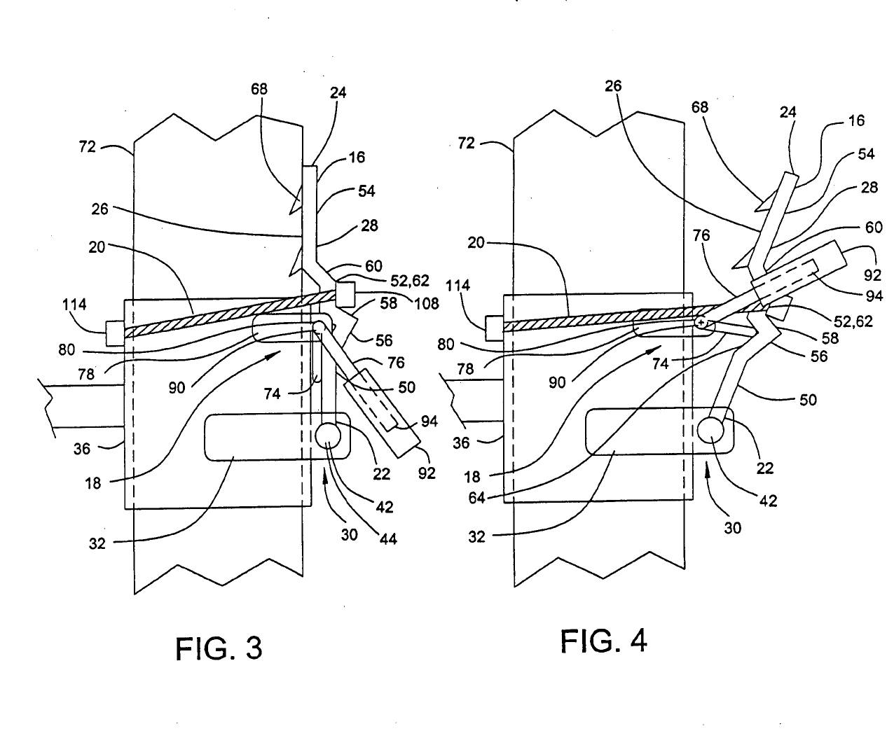

Referring to the drawings, specifically FIGS. 1 and 3 a preferred deck safety slip pin system 10 according to the present invention is illustrated. The deck safety slip pin system 10 includes a mechanical locking device 12 that maintains a deck 14 in a raised position. As described in more detail below the locking device 12 includes a pawl 16, a release mechanism 18, and a biasing device 20.

Referring to FIGS. 3-5, the pawl 16 is formed from a generally rectangular plate having first and second ends 22 and 24 and inner and outer surfaces 26 and 28. The pawl 16 has a hinge structure 30 at the first end 22. The hinge structure 30 includes first and second ears 32 and 34 which are welded to a post slider 36 or sleeve 38 (see FIG. 7) on the trailer 40. The hinge structure 30 also includes a pin 42 having first and second ends 44 and 46 welded to the first and second ears 32 and 34 respectively. The pin 42 is oriented transverse to the length of the ears 32 and 34. The hinge structure 30 also includes a tubular sleeve 48 that fits over and may be rotated around the pin 42. The tubular sleeve 48 is welded to the rectangular plate of the pawl 16.

Between the first and second ends 22 and 24, the pawl 16 is formed so as to define generally planar primary, intermediate, and secondary sections 50, 52 and 54 as well as generally angled first, second, and third connecting sections 56, 58 and 60.

The primary planar section 50 extends from the first end 22 of the pawl 16. The primary planar section 50, at its end opposite of the first end 22 of the pawl. 16, integrally merges with the first connecting section 56. The first connecting section 56 is angled outwardly and integrally merges with the second connecting section 58. The second connecting section 58 angles back inwardly. The second connecting section 58 integrally merges with the intermediate planar section 52. The intermediate planar section 52 is oriented preferably in the same plane as the primary planar section 50. The intermediate planar section 52 provides a seat 62 for the biasing device 20. The intermediate planar section 52 integrally merges with the third connecting section 60. The third connecting section 60 is angled inwardly and integrally merges with the secondary planar section 54. The secondary planar section 54 extends from the point of merger with the third connecting section 60 to the second end 24 of the pawl 16. The secondary planar section 54 preferably is parallel to the primary planar section 50, but on a plane further inside than the plane of the primary planar section 50.

The pawl 16 also includes a notch 64 on its inner surface. The notch 64 is defined by the first and second connecting sections 56 and 58. Preferably the first and second connecting sections 56 and 58 have a relative orientation of about 90 degrees. The notch 64 extends along the entire width of the pawl 16. One end of the notch 64 may be enclosed by a plate affixed to the pawl 16.

The pawl 16 includes one or more slip pins or teeth 68 on the inner surface of the secondary planar section 54. The teeth 68 are for engaging receptacles 70 upon a support post 72. The teeth 68 are affixed to the secondary planar section 54, preferably by welding. Preferably, the teeth 68 have a generally conical shape. Alternatively, the teeth 68 may have a square shape. Tooth 68 shape depends upon the shape of the receptacles 70 (see FIG. 7) within the support post 72. The teeth 68 are angled in a direction that depends upon the relative motion of the support post 72 as described in more detail below. As shown the teeth 68 are angled away from the second end 24 of the pawl 16. In an embodiment of the pawl 16 including a plurality of teeth 68, the teeth 68 are configured in line with a central axis defined along the length of the pawl 16. Preferably the pawl 16 and the teeth 68 affixed thereto are made from steel.

The release mechanism 18 includes a release arm 74, a lever arm 76, and a hinge structure 78. The release arm 74 is pivotally affixed at a first end 80 to the hinge structure 78 of the release mechanism 18. The hinge structure 78 has a construction similar to the hinge structure 30 of the pawl 16, including two ears 82 and 84, a pin 86 and a tubular sleeve 88. The release arm 74 is preferably a rectangular plate. The lever arm 76 is also pivotally attached at a first end 90 to the hinge structure 78 of the release mechanism 18. The lever arm 76 is a bent extension of the pin 86 and is oriented at about an 18 degree offset from the release arm 74. This angle of offset is maintained in all rotational positions of the release mechanism 18. The lever arm 76 includes a cup 92 at its second end. The cup 92 is adapted to receive the end of a tool (not shown), such as a rod or pole that actuates the release mechanism 18.

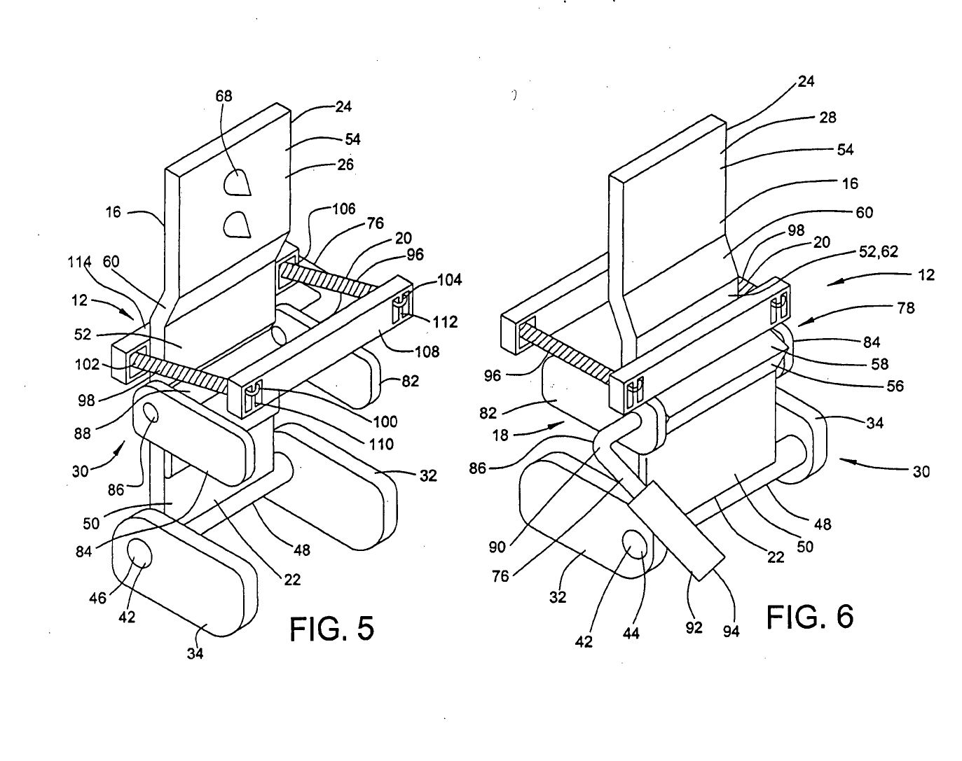

Referring to FIGS. 1 and 5 the biasing device 20 comprises a system of two springs 96 and 98, each having first (100, 104) and second (102, 106) ends. Additionally, a bar 108 is supported between the first ends 102 and 104 of each spring 96 and 98. The bar 108 of the biasing device 20 is a rectangular solid including integral posts 110, 112 formed within the bar 108 at each of its ends. Each spring 96 and 98 is affixed at its first end 100 and 104 to the bar 108 and at its second end 102 and 106 to a mounting element 114 that is welded to another part of the trailer 40 as described below.

A second embodiment of the deck safety slip pin system 10 is shown in FIG. 7. In the second embodiment, the structure of the release mechanism 18 is varied. The lever arm 76 is affixed to the hinge structure 78 in a different orientation. The lever arm 76 is offset at about a 60 degree angle from the release arm 74. The cup 92 is oriented to allow actuation by an operator from below the locking device 12.

In the first illustrated embodiment (FIGS. 3 and 4), the release mechanism 18 is placed on the inner surface 26 of the pawl 16 between the pawl 16 and the post slider 36 (described hereinafter) such that the hinge 78 of the release mechanism 18 fits within the notch 64 defined by the pawl 16. Additionally, the release mechanism 18 is oriented such that, upon actuation, the release arm 74 rotates into position to be received within the notch 64 defined by the pawl 16. The lever arm 76 of the release mechanism 18 is offset from the body of the pawl 16 so as to project laterally away from the pawl 16 and thereby allow the lever arm 76 to be moved without direct interference by the pawl 16.

The bar 108 of the biasing device 20 is oriented transverse to the length of the pawl 16 and abuts the seat 62 defined by the intermediate planar section 52 of the pawl 16. As a result, the pawl 16 is pulled towards the support post 72 by the biasing device 20.

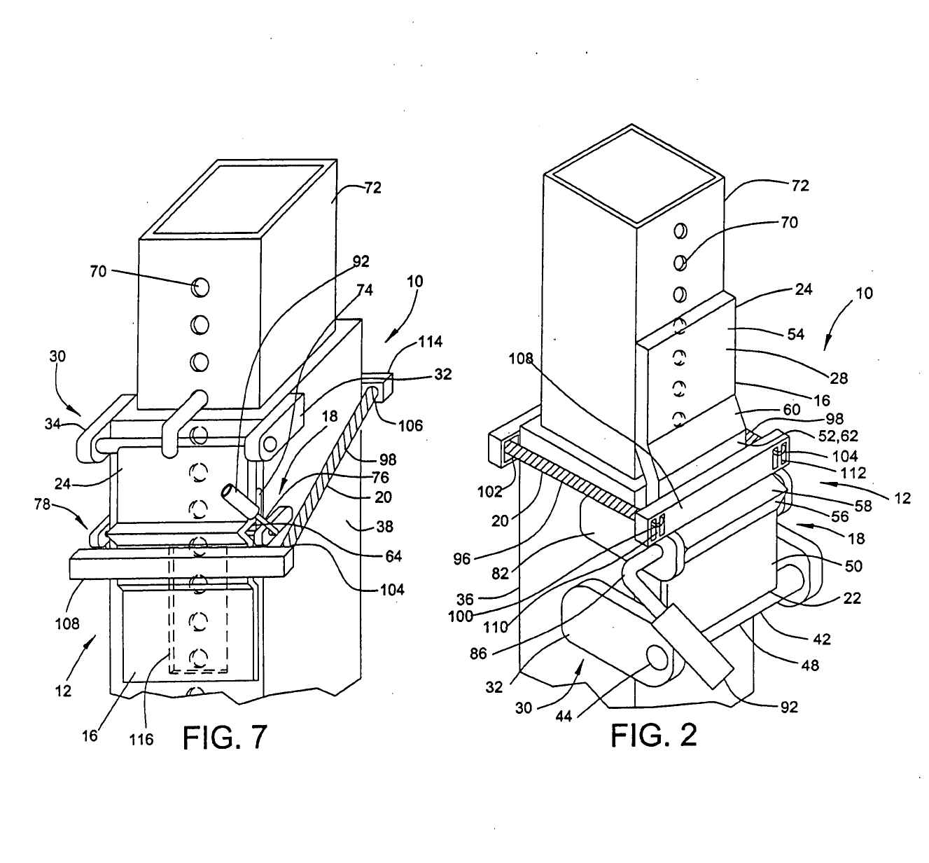

Referring to FIGS. 1-6, the pawl hinge structure 30 is affixable to the other members, or mounts, of the trailer 40. In the deck raising system where the support post 72 is static, the pawl hinge structure 30 is affixed to the post slider 36. This first embodiment of the locking device 12 is oriented with the pawl hinge structure 30 at the first end 22 of the pawl 16. The hinge structure 30 is attached by welding the ears 32 and 34 on the hinge structure 20 to the post slider 36. The hinge structure 30 is mounted with an orientation transverse to an axis defined by the length of the deck support post 72. In a similar manner, the hinge structure 78 of the release mechanism 18 is attached to the post slider 36 as described herein before. The hinge structure 78 of the release mechanism 18 is welded in place in an orientation generally parallel to the hinge structure 30 upon the pawl 16. Additionally the mounting elements 114 of the biasing device are attached, preferably by welding, to the post slider 36.

Referring to FIG. 7, in the deck safety slip pin system 10 where the support post 72 is movable, the pawl hinge structure 30 is affixed to the static sleeve 38 at the base of the support post 72. This second embodiment of the locking device 12 is oriented with the pawl hinge structure 30 at the second end 24 of the pawl 16. A hole 116 is incorporated into the static sleeve 38 that allows the teeth 68 of the locking device 12 to access receptacles 70 on the support post 72. The hinge structure 30 is attached by welding the ears 32 and 34 on the hinge structure 30 to the static sleeve 38. The hinge structure 30 is mounted with an orientation transverse to an axis defined by the length of the deck support post 72. In a similar manner, the hinge structure 78 of the release mechanism 18 is attached to the static sleeve 38. The hinge structure 78 of the release mechanism 18 is welded in place in an orientation generally parallel to the hinge structure 30 upon the pawl 16. Additionally the mounting elements 114 of the biasing device 20 are attached, preferably by welding, to the static sleeve 38.

Referring to FIGS. 1-7, the deck safety slip pin system 10 functions to releasably lock a car carrier deck 14 in position with respect to rest of the car carrier or trailer 40. The pawl 16 of the locking device 12 is affixed to the trailer 40 and engages the support post 72 that moves relative to the locking device 12. The secondary planar section 54 of the pawl 16 brings the teeth 68 of the pawl 16 in close proximity to the support post 72 when the pawl 16 is affixed to a post slider 36 in a first embodiment of the locking device 12 or static sleeve 38 in a second embodiment of the locking device 12. The biasing device 20 keeps the teeth 68 of the pawl 16 in selective contact with the support post 72. The pawl hinge structure 30 allows the pawl 16 to move pivotally with respect to the support post 72.

As the support post 72 moves relative to the pawl 16, receptacles 70 within the support post 72 periodically approach the teeth 68 of the pawl 16. The biasing device 20 urges the teeth 68 on the pawl 16 into the receptacles 70 upon the support post 72 as they become aligned. As the support post 72 continues to move relative to the pawl 16, the angled tooth surfaces causes the tooth 68 to cam back out of the receptacle 70 against the biasing force of the biasing device 20. As the next receptacle 70 approaches the teeth 68, the process is repeated. The teeth 68 of the pawl 16 are preferably oriented in a direction that allows the teeth 68 to repeatedly perform this ratchet-like operation when the deck 14 is raised.

However, when the deck 14 is lowered, intentionally or accidentally, the teeth 68 are biased into engagement within the receptacles 70, but are not angled in a way which allows them to cam out of the receptacles 70. Thus, the deck 14 is locked in position. Activation of the release mechanism 18, as described below, is necessary to disengage the teeth 68 from the receptacles 70.

Preferably, the teeth 68 in the pawl 16 engage receptacles 70 within the support post 72 when the support post 72 is in a desired raised position. Alternatively, in a desired raised position, the teeth 68 of the pawl 16 abut the support post 72 sides, but engage the support post receptacles 70 only when the deck 14 moves downwardly, such as when there is a failure in the hydraulic lifting system. Since multiple receptacles 70 are provided on the support post 72, failure of the hydraulic system at any time while raising the deck 14 will not result in lengthy downward travel of the deck 14 before the teeth 68 engage one set of the receptacles 70.

The release mechanism 18 is movable between an operating position (see FIG. 3) and a resting position (see FIG. 4). In a resting position the release arm 74 is generally parallel to the axis defined by the length of the deck support post 72 and permits the teeth 68 in the pawl 16 to engage the receptacles 70 in the support post 72. The notch 64 of the pawl 16 is oriented on the inner surface 26 of the pawl 16 and may receive the release arm 74 of the release mechanism 18 when the release mechanism 18 is actuated. The notch 64 also provides clearance space for a hinge structure 30 of the release mechanism 18.

The release mechanism 18 is moved into the operating position when actuated, allowing the deck 14 to be lowered in normal operating conditions by a functioning hydraulic system. In an operating position, the release arm 74 is rotated about ninety degrees from its resting position away from the post slider 36 against the biasing device 20 so as to pivot the pawl 16 relatively away from the support post 72 and thereby disengage the pawl teeth 68 from the support post 72. Receipt of the release arm 74 in the notch 64 holds the release mechanism 18 in the operating position. Once the pawl 16 has been disengaged the teeth 68 no longer restrict the relative movement between the pawl 16 and support post 72. Typically, when the release mechanism 18 is actuated the pawl teeth 68 are either not engaging the support post receptacles 70 or are engaged while the hydraulic system holds up the deck 14. As a result, there is little resistance to actuation of the release mechanism 18. Due to the weight of the deck 14 and any vehicles thereon that is applied against the pawl teeth 68, the release mechanism 18 cannot be actuated when the hydraulic system is in a failure condition.

The release mechanism 18 is returned to a resting position manually by an operator when the trailer decks 14 are in a lowered position. The second embodiment of the locking device 12 functions in an identical manner.

In an alternate way of forming the teeth 68 within the pawl 16, the teeth 68 are cast integrally with the pawl 16, machined out of the rest of the pawl 16 body or threaded into apertures provided in the pawl 16.

In an alternative way of providing hinges for the pawl 16 and release mechanism 18, a single pin, having ends of a reduced diameter, is rotatably supported by the two ears 32 and 34 that are in turn welded to the post slider 36 or sleeve 38. The pawl 16 is welded directly to the pin. Similarly the release arm 74 of the release mechanism 18 may be welded directly to a pin in a similar configuration. The lever arm 76 ma be shaped like a rectangular plate.

In an alternative way of mounting the springs of the biasing device 20 to the pawl 16, eye bolts are affixed to the bar 108 of the biasing device 20 and the springs are attached to the eye bolts.

The deck safety slip pin system 10 of the present invention removes the need for the car carrier or trailer operator to activate a safety lock for deck supports manually. The locking device 12 of the present system is easily retrofitted onto the existing components of a car carrier or trailer. The locking device 12 only requires manual actuation for disengagement. In hydraulic system failure conditions, the support deck 14 moves minimally, if at all, before the locking device 12 engages, thus, very little hydraulic fluid is expelled from the system.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents.

1. A car carrier deck safety locking device for use in conjunction with a car carrier and its support post, said locking device comprising:
a pawl pivotally affixable to the car carrier, said pawl including a tooth for selective engagement with a receptacle upon the support post; and
a biasing device engaging said pawl and the car carrier and biasing said pawl tooth against the support post; and
an actuatable release mechanism for disengaging said pawl tooth from the receptacle upon the support post.

2. The locking device of claim 1 wherein said actuatable release mechanism includes a release arm and lever arm pivotally affixable to the car carrier whereby rotation of said lever arm biases said release arm against said pawl causing disengagement of said pawl from the support post.

3. The locking device of claim 2 wherein said lever arm has a fixed orientation with respect to said release arm.

4. The locking device of claim 1 wherein said biasing device comprises first and second springs and a bar supported therebetween.

5. The locking device of claim 1 wherein said pawl is affixable to a post slider upon the car carrier.

6. The locking device of claim 1 wherein said pawl is affixable to a sleeve surrounding the support post of the car carrier.

7. The locking device of claim 1 wherein said pawl includes a plurality of teeth.

8. The locking device of claim 1 wherein said pawl defines a notch adjacent to said release mechanism.

9. The locking device of claim 1 wherein said pawl tooth has an angle of orientation whereby said tooth will ride over a receptacle upon the support post as the support post moves relative to said tooth in a first direction and said tooth will engage the receptacle upon the support post as the support post moves relative to said tooth in an opposite direction.

10. A car carrier deck safety locking device for use in conjunction with a car carrier and its support post, said locking device comprising:
a pawl pivotally affixable to the car carrier, said pawl including a tooth for selectively contacting the support post; and
an actuatable release mechanism for selectively spacing said pawl tooth from the support post.

11. A car carrier deck safety slip pin system for use upon a car carrier support post, said locking device comprising:
a post slider slidingly engageable with the support post;
a pawl pivotally affixed to said post slider, said pawl including a tooth for selective engagement with a receptacle upon the support post; and
a biasing device engaging said pawl and said post slider and biasing said pawl against the support post; and
an actuatable release mechanism for disengaging said pawl tooth from a receptacle upon the support post.

12. A car carrier comprising:
a trailer member including lower deck members and upper deck members;
a support post including a plurality of receptacles, said support post supporting one of said upper deck members;
a mount affixed to said trailer member and in sliding engagement with said support post;
a pawl pivotally affixable to said mount, said pawl including a tooth for selective engagement with said receptacles upon said support post; and
a biasing device engaging said pawl and said post slider and biasing said pawl against said support post; and
an actuatable release mechanism for disengaging said pawl from said support post.

13. The car carrier of claim 12 wherein said mount is a post slider affixed to an upper deck member.

14. The car carrier of claim 12 wherein said mount is a sleeve surrounding the support post.
